(19) United States
(12) Patent Application Publication
(10) Pub. No.: US 2017/0147480 A1
(43) Pub. Date: May 25, 2017

(54) TEST SCRIPT GENERATION

(71) Applicant: GOOGLE INC., Moutain View, CA (US)

(72) Inventors: MANISH LACHWANI, SUNNYVALE, CA (US); JAY SRINIVASAN, SAN FRANCISCO, CA (US); PRATYUS PATNAIK, SAN FRANCISCO, CA (US)

(21) Appl. No.: 13/868,560

(22) Filed: Apr. 23, 2013

(51) Int. Cl. G06F 11/36

(52) U.S. Cl. CPC G06F 11/3684

(57) ABSTRACT

Systems and methods are described for building application test scripts based on input data from one or more host devices resulting from user interaction with the one or more host devices. The input data is processed to generate input event data which associates the input with a particular user interface element. Based on the input event data, test scripts may be generated. Test scripts may thus be quickly built from user interactions with the host devices. Because the test scripts are associated with particular elements in the user interface, they are resilient to changes which may occur during ongoing development.

### BACKGROUND

With the growing popularity of computing devices, there is an increasing demand for applications, or apps, to run on such devices. These devices may include smartphones, tablet computers, televisions, set-top boxes, in-vehicle computer systems, home entertainment systems, wearable devices, and so forth. To satisfy this demand, programmers are constantly building, testing, and maintaining applications. To ensure high quality and to identify problems, many app developers test their apps before launching them to the public. However, app testing may be time- and resource-intensive, particularly in cases where the app is to be tested on many different mobile devices running a variety of mobile operating systems of various versions under various use conditions.

### BRIEF DESCRIPTION OF THE DRAWINGS

FIG. 1 depicts a system for testing an application on one or more host devices using test scripts generated based on input data acquired during use of the application.

FIG. 2 depicts a block diagram of the input data.

FIG. 3 illustrates receiving input data from a user and the application objects associated with the input data.

FIG. 4 depicts a block diagram of a build server configured to facilitate development of the application by sending applications for testing using a test server.

FIG. 5 depicts a block diagram of the test server configured to generate test scripts, and test the application using these scripts.

FIG. 6 depicts a block diagram of the host device which may be configured to generate input event data may be controlled by the test server, or controlled by an individual user.

FIG. 7 depicts a user interface of testing options and results which may be presented to a user.

FIG. 8 depicts a flow diagram of a process to use input event data to generate a test script.

FIG. 9 depicts a flow diagram of a process to generate input event data based on touch inputs.

FIG. 10 depicts a flow diagram of a process of application test using the generated test script.

Certain implementations and embodiments will now be described more fully below with reference to the accompanying figures, in which various aspects are shown. However, various aspects may be implemented in many different forms and should not be construed as limited to the implementations set forth herein. Like numbers refer to like elements throughout.

### INCORPORATION BY REFERENCE

U.S. patent application Ser. No. 13/619,867, filed on Sep. 14, 2012, titled “Remote Control of a Mobile Device” to Manish Lachwani, et al. is incorporated by reference into this disclosure.

U.S. patent application Ser. No. 13/680,671, filed on Nov. 19, 2012, titled “Configurable Network Virtualization” to Manish Lachwani, et al. is incorporated by reference into this disclosure.

U.S. patent application Ser. No. 13/631,919, filed on Sep. 29, 2012, titled “Application Validation Through Object Level Hierarchy Analysis” to Manish Lachwani, et al. is incorporated by reference into this disclosure.

U.S. patent application Ser. No. 13/655,667, filed on Oct. 19, 2012, titled “Application Auditing Through Object Level Code Inspection” to Manish Lachwani, et al. is incorporated by reference into this disclosure.

U.S. patent application Ser. No. 13/721,632, filed on Dec. 20, 2012, titled “System For Testing Markup Language Applications” to Manish Lachwani, et al. is incorporated by reference into this disclosure.

U.S. patent application Ser. No. 13/741,989, filed on Jan. 15, 2013, titled “Application Testing System With Application Programming Interface” to Manish Lachwani, et al. is incorporated by reference into this disclosure.

U.S. patent application Ser. No. 13/862,240, filed on Apr. 12, 2013, titled “Test Automation API For Host Devices” to Manish Lachwani, et al. is incorporated by reference into this disclosure.

### DETAILED DESCRIPTION

A wide variety of applications (or “apps”) are developed for execution on computing devices including smartphones, tablet computers, televisions, set-top boxes, in-vehicle computer systems, home entertainment systems, wearable devices, and so forth. There is an increasing demand for software users to build apps to run on such devices. Software users build, test, and maintain applications using a variety of development and build tools. Testing provides many benefits including finding and correcting errors, improving performance, and so forth. Testing may include observing processor usage, observing memory allocation, programmatic debugging, determining usability, validating functionality, identifying regressions, and so forth.

Traditional testing has involved manual testing or image comparison/optical character recognition techniques. The manual testing utilizes users, sometimes known as “quality assurance” or “testers”, to manually step through user interface elements of an application and exercise the application while noting failures. However, this is costly, prone to error, and requires significant time to complete.

Attempts have been made to automate the testing process with testing frameworks using image comparison, optical character recognition, or both. However, these frameworks are brittle, in that small changes to the user interface such as a change in font, altered display label, different screen resolution, change in color, and so forth may result in breakage of the test script or false error reporting. As a result, separate tests may need to be manually generated by developers to run on host devices with different form factors, such as screen resolution.

Test frameworks may allow for the testing of application internals. For example, unit tests may use test scripts which exercise a particular class, method, function, or other unit of code. However, traditional development of these test scripts has been time consuming. As a result, a developer may need to spend 10-15% of their time writing code such as test scripts to implement unit or other tests. However, the developer may not have the time to dedicate to writing these tests. As a result, developers are faced with a dilemma to write code for an application under development, or to write tests for the application under development.

Described in this disclosure are systems and techniques for acquiring input data from one or more host devices which are executing the application under test. The input data is based at least in part on user inputs made to the host device. The input data may include user inputs such as touches on a touchscreen, motion of the device, activation of buttons, as well as data from other sensors or systems on the host device.

The input data is processed to generate input events. The input events associate portions of the input data with application objects or user interface elements of the application under test. For example, an input event may be based on input data designating a touch at a particular set of coordinates on the touchscreen and a particular UIView object or other user interface element in the application under test.

The input events, which describe input data and associated user interface elements or objects, may then be used to build one or more test scripts. These test scripts may then be used as generated, or modified by a developer and subsequently replayed to exercise the application under test. Using this technique, user interaction may be used to generate the test script. The test script may then be modified by a developer. However, this modification is significantly less time intensive compared to manually generating the entire test script by hand. The test scripts may be provided in various formats, such as the Ruby language as created by Yukihiro Matsumoto and derivatives, the UIAutomation framework promulgated by Apple Corp. of Cupertino, Calif., and so forth.

Using these techniques, test scripts may be generated quickly and easily. Instead of tediously coding by hand, test scripts may be rapidly built by developers interacting with the host devices executing the application under test to provide input data. The test scripts may also be generated from input data coming from non-developer users 102(2)-(U), such as beta testers, interacting with the application under test. As a result, test scripts may be built which are representative of real-world use. The developer or an automated process may then modify the resulting test scripts to add conditional tests, account for tested elements which may change, and so forth. Furthermore, because the test scripts have been generated using the input event data, they exercise particular application objects or elements. The resulting test remains functional even in situations which would break testing which relies on image comparison, optical character recognition, and so forth. For example, the test scripts generated as described in this disclosure will still work for a build of the application in which a screen color changes or a control button moves, relative to a previous build. Furthermore, when the build of the application has evolved such that the test script no longer works, another may be quickly and easily generated and modified to enable further testing.

### Illustrated Environment

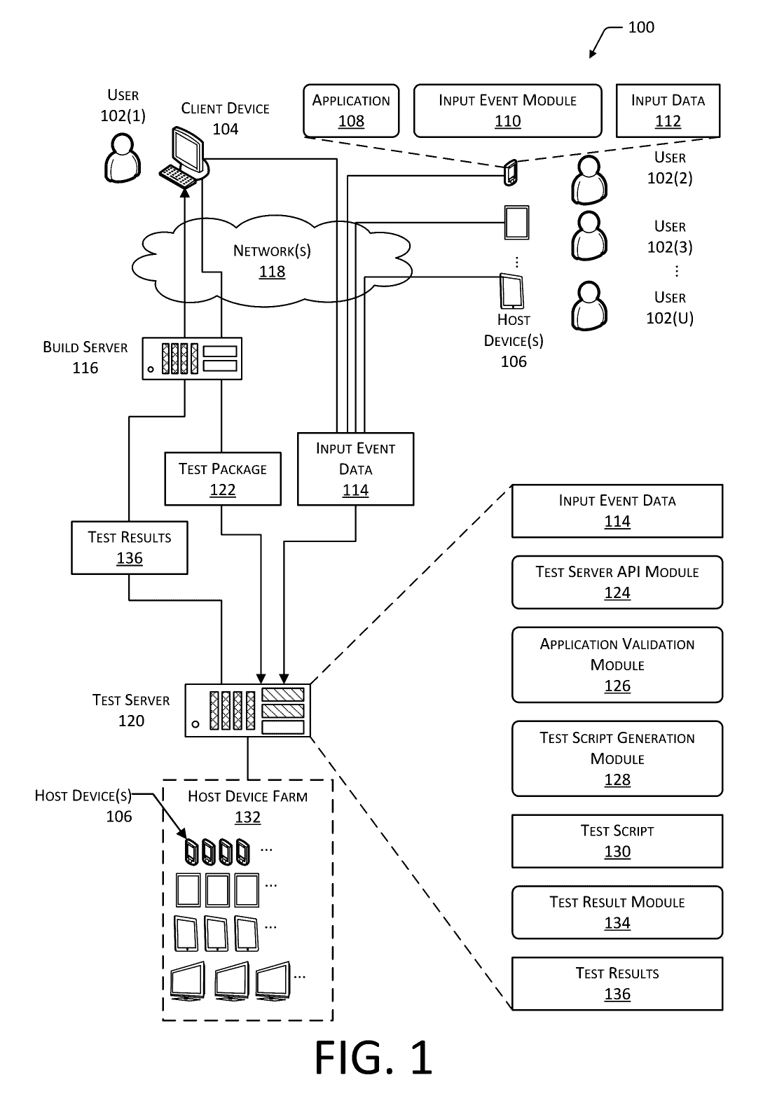

FIG. 1 depicts a system 100 for testing an application on one or more host devices using test scripts generated based on input data acquired during use of the application. One or more users 102, such as software developers, quality assurance testers, and so forth, may use one or more client devices 104, host devices 106, or both. The client devices 104 may be configured to aid in software development and may include laptop computers, desktop computers, terminals, and so forth. The host devices 106 may include an application 108 undergoing initial development, ongoing development, maintenance, and so forth.

The application 108 may be a native app, a markup language application, hybrid app, or a browser-based application. Native applications are those which are written and compiled for execution on the particular device. For example, native applications may be written in a programming language such as C++ or Objective C and compiled into native code such as a binary executable for use on the device. Markup language applications include one or more instructions in a markup language which may be rendered by a layout engine and one or more instructions in a scripting language which may be interpreted by a scripting language engine during execution. For example, a hypertext markup language (“HTML”) version 5 (or greater) markup language application may include HTML, cascading style sheets (“CSS”), and JavaScript. In some implementations the markup language application may have multiple instances of the UIWebView class references. Hybrid applications include native code and markup language application portions. Browser-based applications are processed within a web browser application and are limited in execution. The browser-based applications may have only a single UIWebView instance.

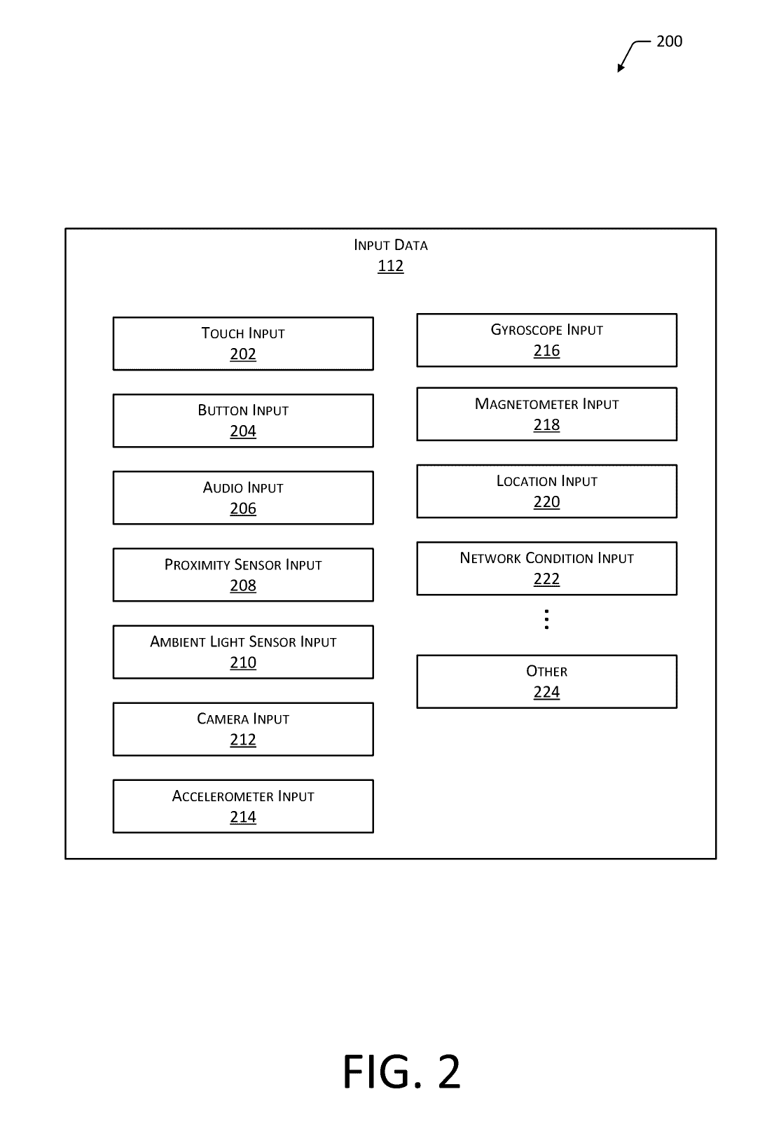

The host device 106 may also include an input event module 110. The input event module 110 is configured to receive input data 112 associated with the application 108. The input data 112 comprises information which is provided as input to the application 108. The input data 112 may include touches on a touchscreen of the host device 106, button presses on the host device 106, or information from other sensors which is used by the application 108. The input data is described in more detail below with regard to FIG. 2.

The input event module 110 uses the information in the input data 112 to generate input event data 114. For example, the input data 112 may comprise coordinates for the position of a touch user input. The input event module 110 determines one or more associated application objects, such as a UIView object, which correspond to the touch user input. Using this technique, the input event data 114 contains information about the touch or other input and corresponding application object, rather than simply a set of coordinates on a touch sensor. In some implementations, the input event module 110 may be configured to generate or use a previously generated object level hierarchy, such as described below.

Below is a sample of input event data 114 which associates touch inputs 202 with particular application objects. As used in this disclosure, “phase” describes a portion of a touch, such as touch begins, touch ends, touch moves, and so forth. “UIATarget.localTarget( )” indicates the application 108 which is under test, while “view=” is the view responding to the touch input. “NSPoint:” indicates the screen coordinates of the touch.

Portion of Sample Input Event Data

Jan 1 15:26:47 Test-Device iAlice[16627]:
UIATarget.localTarget( )=NSPoint: {108, 215.5}, 0
Jan 1 15:26:47 Test-Device iAlice[16627]: UIATarget phase=0,
view=<UITableViewCellContentView: 0x1f094fa0; frame = (0 0;
320 43); gestureRecognizers = <NSArray: 0x1f095180>; layer =
<CALayer: 0x1f095000>>
Jan 1 15:26:47 Test-Device iAlice[16627]:
UIATarget.localTarget( )=NSPoint: {109, 216}, 0
Jan 1 15:26:47 Test-Device iAlice[16627]: UIATarget phase=3,
view=<UITableViewCellContentView: 0x1f094fa0; frame = (0 0;
320 43); gestureRecognizers = <NSArray: 0x1f095180>; layer =
<CALayer: 0x1f095000>>
Jan 1 15:26:47 Test-Device iAlice[16627]:
UIATarget.localTarget( )=NSPoint: {0, 0}, 0
Jan 1 15:27:18 Test-Device iAlice[16627]:
UIATarget.localTarget( )=NSPoint: {59, 255.5}, 0
Jan 1 15:27:18 Test-Device iAlice[16627]: UIATarget phase=0,
view=<Block: 0x1dd07030; baseClass = UIControl; frame = (10
122.827; 93.3333 93.3333); layer = <CALayer: 0x1dd06d40>>

The input event module 110 may comprise code which is dynamically injected into the application 108 at runtime. In another implementation, the code to provide the input event module 110 functionality may be linked and incorporated at compile time, when the application 108 is compiled. For example, the input event module 110 may be implemented as a software development kit (“SDK”). The input module 110 as an SDK may be provided as a static library which the developer user 102 may then link to. For example, this library may be linked while in the Xcode link phase.

In implementations where the input module 110 is operating on platforms using the iOS® operating system, the input module 110 may be configured to extend the functionality of the UIApplication class. In one implementation, the following may be added to the UIApplication class to support the functionality described herein:

Example Extension of UIApplication Class

@interface UIApplication (Recorder)
−(void) _addRecorder:(id<UIEventRecorder>)recorder ;
−(void) _removeRecorder:(id<UIEventRecorder>)recorder ;
−(void) _playback:(NSArray*)events
atPlaybackRate:(float)playbackRate messageWhenDone:(id)target
withSelector:(SEL)action ;
@end
Extends the functionality of the UIEvent class:
@interface UIEvent (Synthesize)
−(id) _initWithEvent:(id)event touches:(NSSet*)touches;
@end
Creates EventRecorder class:
#define EVENTRECORDER [EventRecorder sharedRecorder]
@protocol UIEventRecorder
−(void)recordApplicationEvent:(NSDictionary*)event ;
@interface EventRecorder : NSObject <UIEventRecorder> {

NSMutableArray* userEvents;
BOOL recorded;

}
@property (nonatomic) BOOL recorded;
@property (nonatomic, retain) NSMutableArray* userEvents;
+(EventRecorder*) sharedRecorder ;
−(void) enableRecordEvents ;
−(void) playUserEvents ;
−(void) replayEvents:(NSArray*)events ;
−(void) editUserEvents:(NSArray*)frames ;
−(NSData*) saveEvents ;
−(NSArray*) loadEvents:(NSData*)data ;
−(void) addEvents:(NSArray*)events ;
−(void) clearEvents ;
//−(NSString*) reportEvents ;
@end
Extends UITouch class:
@interface UITouch (Ext)
+(UITouch*) touchWithPoint:(CGPoint)point view:(UIView*)view_{—}
;
+(UITouch*) touchWithPoint:(CGPoint)point view:(UIView*)view_{—}
phase:(UITouchPhase)phase_ ;
−(id) initWithTouch:(UITouch *)touch view:(UIView*)view_ ;
−(id) initWithPoint:(CGPoint)point view:(UIView*)view_{—}
timestamp:(NSTimeInterval)timestamp_{—}
phase:(UITouchPhase)phase_ tapTotal:(NSUInteger)tapTotal_ ;
@end
@interface UIEvent (Ext)
//−(NSDictionary*) to_dict ;
−(id) initWithTouch:(UITouch*)touch ;
@end

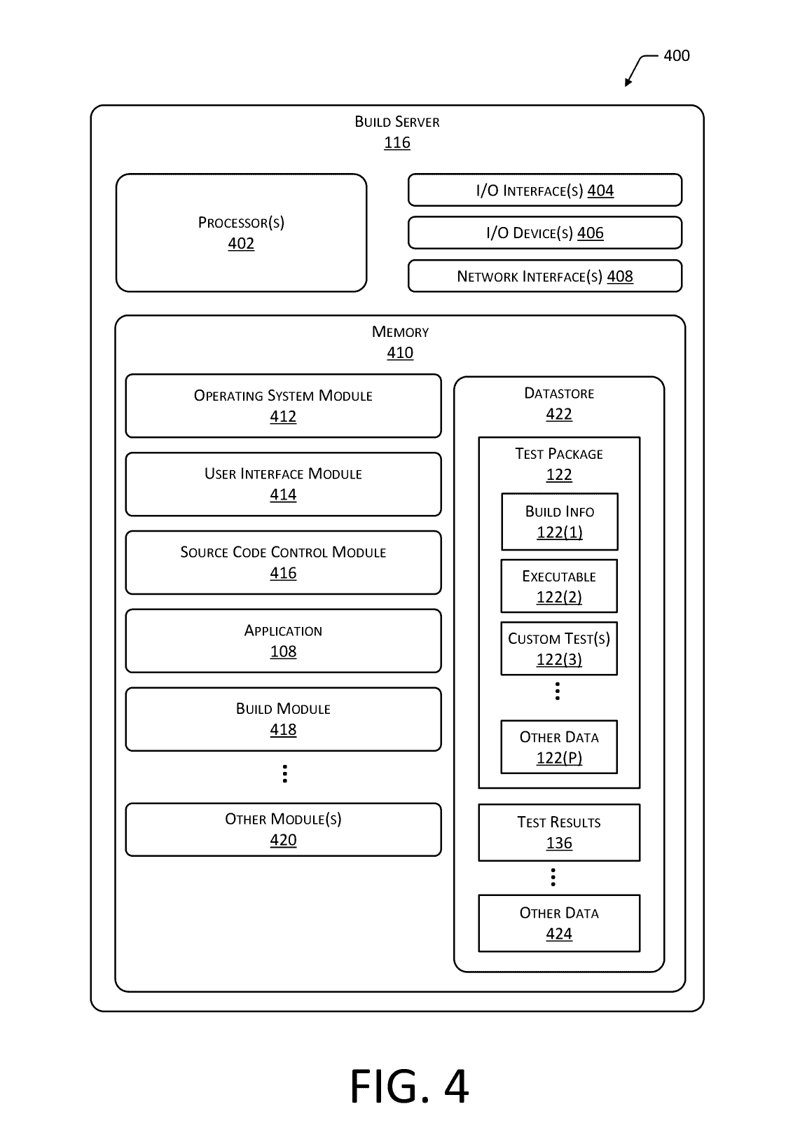

A build server 116 may be used by the developer user 102 to assist in development of the code. The build server 116 may comprise one or more modules. These modules are discussed below in more detail with regard to FIG. 4. In some implementations the application 108 as built may include executable binaries, markup language applications, and so forth. In some implementations the users 102 may use the build server 116 to implement a continuous integration methodology of software development in which workspaces of the users 102 are merged frequently, such as several times per day.

The build server 116 may be configured to implement, or work in conjunction with systems implementing one or more of the Rational ClearCase family of tools from IBM Corp, the Hudson tool developed at least in part by Kohsuke Kawaguchi and available at hudson-ci.org, the Jenkins tool as forked from Hudson and promulgated by Kohsuke Kawaguchi which is available at jenkins-ci.org, Perforce from Perforce Software Inc. of Alameda, Calif., or GitHub from GitHub, Inc. of San Francisco, Calif.

The build server 116 is configured to communicate over one or more networks 118. The networks 118 may include public networks such as the Internet, private networks such as an institutional and/or personal intranet, or some combination of private and public networks. The networks 118 may also include any type of wired and/or wireless network, including but not limited to local area networks (LANs), wide area networks (WANs), Wi-Fi, WiMax, and mobile communications networks (e.g. 3G, 4G, and so forth). The networks 118 may utilize communications protocols, including packet-based and/or datagram-based protocols such as internet protocol (IP), transmission control protocol (TCP), user datagram protocol (UDP), or other types of protocols.

The build server 116 may communicate with a test server 120 over one or more networks 118. Communication may be established between the build server 116 and the test server 120. The build server 116 is configured to generate and send the application 108 and a test package 122 to the test server 120. In some implementations, the test package 122 may include an access token. The test package 122 may comprise tests, test scripts, configuration data, build information, and so forth. The build server 116 may send the application 108 and test package 122 using a uniform resource locator (“URL”) which is associated with a particular account on the test server 120. The URL used by the build server 116 to send the test package 122 may be unique to a particular user 102, group of users 102, build server 116, entity, organization, and so forth. Alternatively, the build server 116 may indicate a raw file path corresponding to the location of the application 108 and the test package 122 on a client device 104.

The test server 120 comprises a test server API module 124 configured to accept and respond to the application 108 and the test package 122 sent by the build server 116. In one implementation, the exchange of information between the build server 116 and the test server 120 may be encrypted. For example, transfers of the application 108 and the test package 122 may use hypertext transport protocol secure (“HTTPS”).

As described above, the build server 116 may be configured to implement, or work in conjunction with, various systems to support development. In one implementation the build server 116 may implement a Hudson/Jenkins build server system with plugins configured to interface with the test server 120 using the test server API module 124. The plugins may allow for opening a specific host device 106 with an installed specific build of the application 108 as a post build option. The plugins may also allow for automated calls to the test server 120 to interact with particular builds.

In some implementations the test server 120 may be configured to work with various tools such as ClearCase, Jenkins, Hudson, Perforce, GitHub, and so forth. Similarly, the test server 120 and the services provided by the test server 120 may be configured to integrate with various SDK. For example, integration may be provided for SDKs promulgated by Sencha Inc. of Redwood City, Calif., PhoneGap by Adobe Systems of San Jose, Calif., AppGyver by AppGyver Inc. of San Francisco, Calif., Eclipse by the Eclipse Foundation of Ottawa, Ontario, and so forth. The test server 120, or portions thereof such as the test server API module 124, may be customized to allow for integration with particular users 102 or entities.

An application validation module 126 generates an object level hierarchy for the application, based on the assembly code generated by the assembly code generation module on the host device. In some cases, the test server may iteratively query the assembly code on the host device 106 to determine parent/child hierarchical relationships between various objects associated with the application. The object level hierarchy may then be built based on these determined parent/child relationships. In some embodiments, the objects employed to build the object level hierarchy include those objects associated with a particular object type, aspect, or feature set of the application, and may also be known as “application objects”. For example, embodiments may provide an object level hierarchy of objects associated with UI elements of the application under validation, or associated with memory management features of the application. The application validation module 126 may also be configured to validate and verify that the application 108 meets design and development requirements.

The application validation module 126 is discussed in more detail with regard to U.S. patent application Ser. No. 13/631,919, filed on Sep. 29, 2012, titled “Application Validation Through Object Level Hierarchy Analysis” to Manish Lachwani, et al. which is incorporated by reference into this disclosure. In some implementations, the object level hierarchy information may be provided to the input event module 110 executing on the host devices 106 which are under control of the test server 120. This information may be used by the input event module 110 to generate the input event data 114.

A test script generation module 128 accepts the input event data 114, containing the input and the associated application objects, and generates one or more test scripts 130. The test scripts 130 may be provided in various formats, such as the Ruby language as created by Yukihiro Matsumoto and derivatives, the UIAutomation framework promulgated by Apple Corp. of Cupertino, Calif., and so forth.

Using these techniques, the test scripts 130 for development may be generated quickly and easily. Instead of tediously coding by hand, test scripts 130 may be rapidly built by developers interacting with the host devices 106 executing the application 108 under test to provide input data. The test scripts 130 may also be generated from input event data 114 coming from non-developer users, such as beta testers, interacting with the application under test. In one implementation, the user 102 may remotely control one of the host devices 106 in a host device farm 132 to execute the interaction and provide various inputs. The resulting input data 112 from this interaction may be processed to generate the test script 130. In another implementation, the application 108 as configured with the input event module 110 may be deployed to one or more host devices 106. The user(s) 102 interact with the application 108, generating the input data 112 which is then used to generate the test scripts 130.

Portion of Sample Test Script Based on Sample Input Event Data

//
// Created by User 102(1) (user102@example.com)
//
//
#import “tuneup_js/tuneup.js”
UIATarget.localTarget( ).setTimeout(5);
function waitForElement( )
{

var done = false;
var counter = 0;
var target = UIATarget.localTarget( );

var milliseconds_before = (new Date).getTime( );
var milliseconds_after;
var diff;

UIALogger.logMessage(“Waiting for activity indicator

to appear, calculating load time”);

while ((!done) && (counter < 60)) {

var progressIndicator =

UIATarget.localTarget( ).frontMostApp( ).windows( )[0].activityIn
dicators( )[0];

if (progressIndicator != “[object UIAElementNil]”) {

target.delay(0.25);
counter++;

}
else {

done = true;

}

}

milliseconds_after = (new Date).getTime( );
diff = milliseconds_after − milliseconds_before;
UIALogger.logMessage(“Load time of the page: “ + diff + ”

milliseconds”);
}
test(“UIA JS Replay”, function(target, app) {
target = UIATarget.localTarget( );
UIALogger.logMessage(“The connected device is an ”
+target.model( ));
UIALogger.logMessage(“The OS is ” +target.systemName( ));
UIALogger.logMessage(“The OS version is ”
+target.systemVersion( ));
UIALogger.logMessage(“The name of the device is ”
+target.name( ));
waitForElement( );
//<UITableViewCellContentView: 0x1f094fa0; frame = (0 0; 320
43); gestureRecognizers = <NSArray: 0x1f095180>; layer =
<CALayer: 0x1f095000>>
// Frame = {{0, 0}, {320, 43}}
waitForElement( );
UIATarget.localTarget( ).logElementTree( );
var WindowArray =
UIATarget.localTarget( ).frontMostApp( ).windows( );
var Windows = WindowArray.toArray( );
UIALogger.logMessage(“Frame: {{ “ + 0 + ”, “ + 0 + ”}, “ + 320
+ ”, “ + 43 + ”}}” );
for (var i = 0; i < Windows.length; i++) {

var ElementsArray =

UIATarget.localTarget( ).frontMostApp( ).windows( )[i].elements( )
;

var Elements = ElementsArray.toArray( );
var ElementInfo;
for (var j = 0; j < Elements.length; j++) {

if ( Elements[j] != null ) {

//ElementInfo =

Elements[j].logElement( );
UIALogger.logMessage(“ElementAtPosition: ” +
Elements[j].name( ));

}

}

}
UIATarget.localTarget( ).tap({x:108,y:215.5});
//<Block: 0x1dd07030; baseClass = UIControl; frame = (10
122.827; 93.3333 93.3333); layer = <CALayer: 0x1dd06d40>>
// Frame = {{10, 122.827}, {93.3333, 93.3333}}
waitForElement( );

As a result, the test scripts 130 may be built quickly. Furthermore, test scripts 130 may be generated from, and representative of, real-world use. The developer user 102(1) or an automated process may then modify the resulting test scripts 130 to add condition tests, account for tested elements which may change, and so forth. Furthermore, because the test scripts 130 have been generated using the input event data 114, they exercise particular application objects or elements rather than particular coordinates within the user interface. As a result, the resulting test script 130 remains functional even in situations which would break image comparison, optical character recognition, and so forth.

A test result module 134 is configured to use the one or more test scripts 130 to exercise the application 108 and generate test results 136 based at least in part on information provided by one or more of the host devices 106. The test server API module 124 may be used to provide the test results 136 to the build server 116, the client devices 104, or both. In one implementation, the user 102 may specify the information that is captured and provided in the test results 136. The test result module 134 may also receive data associated with execution of the application 108 by one or more of the host devices 106, such as within the host device farm 132.

The host devices 106 may include smartphones, tablet computers, televisions, set-top boxes, in-vehicle computer systems, home entertainment systems, and so forth. The host device farm 132 may include different varieties of host devices 106. These varieties may reflect differences in hardware, software, configuration, and so forth. For example, the host device farm 132 may include host devices 106 from manufacturer “A”, manufacturer “B”, and so forth. Furthermore, these host devices 106 may be of different generations, capabilities, and so forth. Continuing the example, the host devices 106 from the manufacturer “A” may include tablet computers, smartphones, and so forth.

In some embodiments, the test server 120 may employ one or more input/output (“I/O”) interfaces comprising an electrical or optical connection to couple to the one or more host devices 106 in the host device farm 132. In one embodiment, a universal serial bus (“USB”) 2.0 or better connection may be used to communicatively couple the host device 106 to the test server 120. The USB connection may be used to transfer data from the host device 106 to the test server 120 or another test server 120, using TCP as a communication protocol. The data may include the application 108, testing applications, screenshots, test results, diagnostic data, and so forth.

The test server 120 may also be configured to receive information associated with all the test frameworks associated with the one or more host devices 106. This information may include diagnostic output, testing outputs, screenshots of one or more of the displays of the one or more host devices 106, and so forth. The screenshots may be stored as still images, or combined to form a video stream representative of information presented on the display of the host device 106. The screenshots generated as the one or more host devices 106 execute the application 108 may be received by the test server 120 for analysis, presentation to the user 102, stored, and so forth.

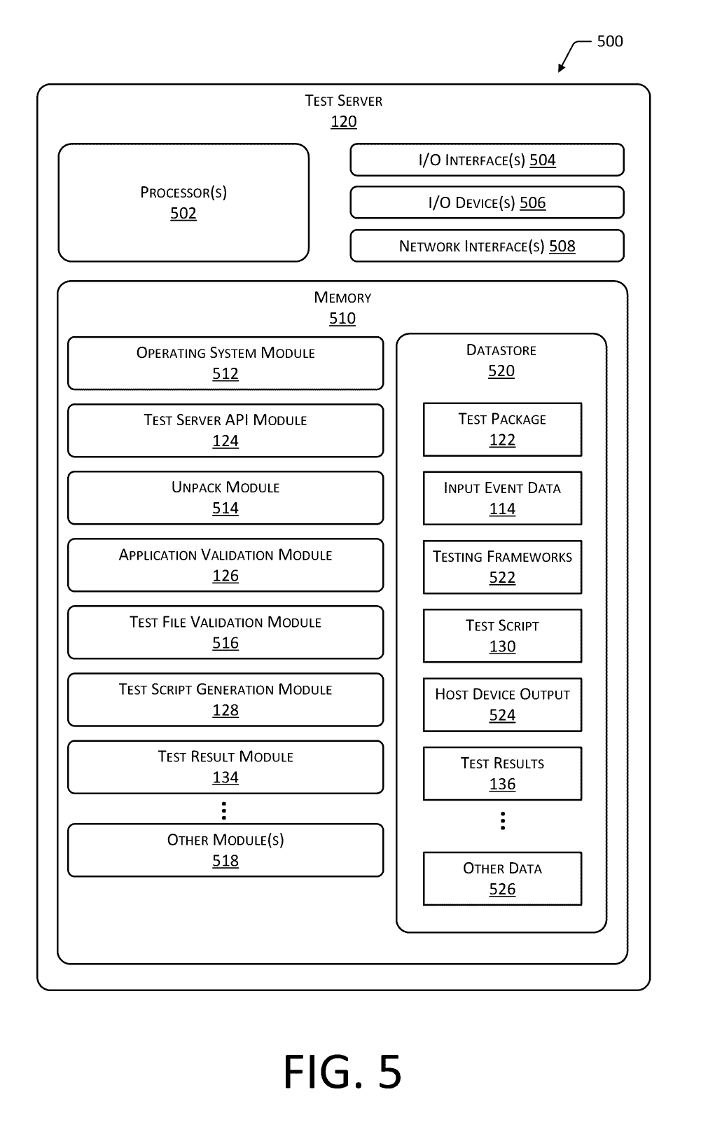

The test server 120 may incorporate other modules. These modules are discussed below in more detail with regard to FIG. 5. For example, the test server 120 may also incorporate a test validation module, a test result module, and so forth. The test validation module may be executed to validate and verify that the test package 122 is a valid file type for the particular framework that is used for testing the application 108.

The build server 116, a client device 104, or both may receive the test results 136. The build server 116 may provide at least a portion of the test results 136, or information based at least in part on the test results 136, to the client devices 104 for presentation to the users 102. In some implementations the build server 116 may use information in the test results 136 to indicate portions of the application 108 which have passed or failed testing by the test server 120. The user 102 may also specify how the test results 136 are to be presented to the user 102. For example, at least a portion of the test results 136 may be emailed to an email address provided by a user 102, posted to the URL specified by a user 102, sent to a client device 104 as the test results 136 are generated using a “keepalive” process, or posted to URL associated with an owner of the test server 120. In some instances, test results 136 that are posted to the URL associated with the owner of the test server 120 may be available for viewing by a user 102 for a predetermined amount of time.

The modules of the build server 116, the test server 120, the host devices 106, and so forth are described in this disclosure as separate modules. In some implementations at least a portion of the functionality of these modules may be combined into a single module, or incorporated into another module. Furthermore, in some implementations the build server 116, the test server 120, and the host device farm 132 may be operated within an organization, particular network, and so forth. For example, a software development company may choose to implement the system 100 for their internal use only.

FIG. 2 depicts a block diagram 200 of the input data 112. The input data 112 comprises information which is provided as input to the application 108. In some implementations, input associated with other applications 108 may not be included in the input data 112. For example, the input event module 110 may be configured to acquire input data 112 about application 108(1). As the user 102 switches between the application 108(1) and application 108(2), user inputs associated with 108(2) are not included in the input data 112.

The input data 112 may be acquired from inputs which the user 102 makes directly on the host device 106. For example, inputs made while the user 102 holds and uses the host device 106.

The input data 112 may also be acquired from apparent or virtual inputs made to the host device 106, such as where the host device 106 is in the host device farm 132. These inputs may be supplied by the test server 120 as coupled to the host devices 106 in the host device farm 132. For example, the user 102(1) may use the client device 104 to remotely control the host device 106 in the host device farm 132. During remote control, inputs such as mouse clicks or keyboard commands entered on the client device 104 may be provided to the host devices 106 as if they were actual user inputs, such as touches on the touchscreen, movement of the device, and so forth.

The input data 112 may include touch input 202 comprising information about a user touch on a touch sensor. This information may include coordinates of a touch on a touch sensor, magnitude of an applied force, shape of the force, and so forth.

Button input 204 may be acquired, such as the user pressing a button or key on the host device 106. Audio input 206, such as microphone input may also be acquired. For example, the user 102 may provide audio input 206 to a speech-enabled application 108.

The input data 112 may also include proximity sensor input 208 from one or more proximity sensors, ambient light sensor input 210 from one or more ambient light sensors, and so forth.

Camera input 212 from one or more cameras may be provided. For example, the application 108 may include barcode reading functionality. Accelerometer input 214, gyroscope input 216, or other motion sensor input may be acquired.

The input data 112 may also comprise magnetometer input 218 from one or more magnetometers. For example, the magnetometer input 218 may comprise information indicative of a compass heading of the host device 106. Location input 220 to the application 108 may also be captured. For example, the latitude, longitude, and position of the host device 106 which are used by the application 108 may be included in the input data 112.

The input data 112 may also include information such as the state of one or more components which support operation of the application 108. In one implementation, where the application 108 uses the network 112 during operation, network condition 222 information which is indicative of one or more wireless networking connections may be acquired. For example, the network condition information may include network provider used, received signal strength, output power, and so forth. Other component information such as battery level, processor usage, memory usage, and so forth may also be provided.

Other input 224 may also be provided, such as data and time, barometric pressure, temperature, and so forth. This input may be generated by the corresponding devices, such as a clock, pressure sensor, thermometer or thermocouple, and so forth.

The input data 112 may be acquired from a variety of input devices. These input devices may include one or more of buttons, microphones, proximity sensors, ambient light sensors, cameras, accelerometers, gyroscopes, magnetometers, location input, or network interfaces.

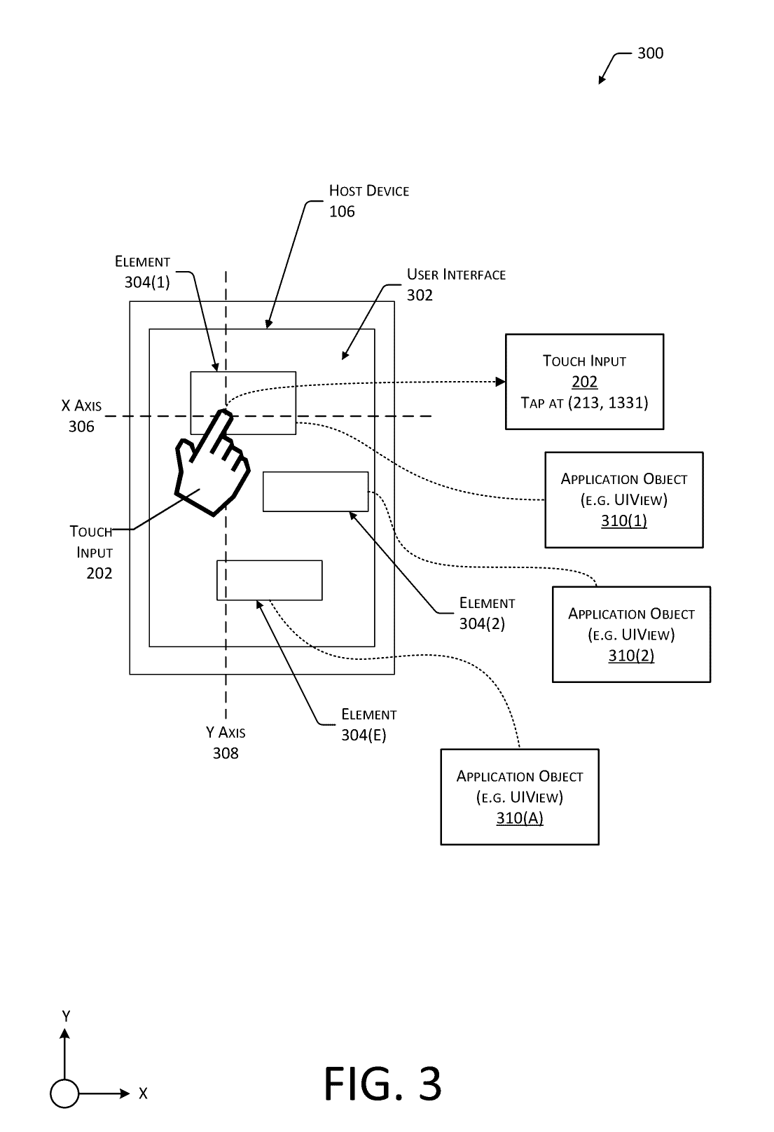

FIG. 3 illustrates receiving user input 300. In this illustration a host device 106 is presenting a graphical user interface 302. The user interface 302 includes several elements 304(1), 304(2), . . . , 304(E). Each of these elements is presented in a particular area on the touchscreen.

Touch input 202 is received at a particular set of coordinates indicative of the location at which the user 102 has touched the touchscreen. In one implementation, such as shown here, coordinates may be expressed as points in a Cartesian coordinate system having an X axis 306 and a perpendicular Y axis 308. For example, in this illustration the touch input 202 is a “tap” or brief touch at the coordinates of X=213 and Y=1331, or (213, 1331).

The touch input 202 depicted here is the user 102 selecting the element 304(1), which may be a user interface object such as a button, or item to select from a list. The location of the touch input 202 corresponds to the application object 310(1). No touch input 202 is associated at this time with other application objects 310(2)-(E).

As described above, the application validation module 126 may generate an application object level hierarchy of the user interface objects. The input event module 110 may compare the coordinates of the touch input with the location of those objects as rendered on the touchscreen. By using this comparison, an association may be determined between the touch input 202 and the corresponding application object 310. For example, the touch input 202 may be determined to correspond to the application object 310(1) (such as a UIView object). The application 108 includes the application objects associated with the user input.

The input event data 114 may be generated from the touch input 202 and the association with the application object 310. For example, the “tap” and the UIView object 310(1) may be associated indicating the user 102 tapped that particular user interface element.

FIG. 4 depicts a block diagram 400 of the build server 116 configured to facilitate development of the application. The build server 116 may include one or more processors 402 configured to execute one or more stored instructions. The processors 402 may comprise one or more cores.

The build server 116 may include one or more input/output (I/O) interface(s) 404 to allow the build server 116 to communicate with other devices. The I/O interface(s) 404 may couple to one or more I/O devices 406. In some embodiments, the I/O device(s) 406 may be physically incorporated with the build server 116 or be externally placed.

The build server 116 may also include one or more network interfaces 408 to enable communications between the build server 116 and other networked devices. Such network interface(s) 408 may include one or more network interface controllers (NICs) or other types of transceiver devices configured to send and receive communications over the network(s) 118. For example, the network interface(s) 408 may be configured to provide a Wi-Fi connection compliant with one or more IEEE 802.11 standards such as 802.11g or 802.11n. The build server 116 may also include one or more busses or other internal communications hardware or software that allow for the transfer of data between the various modules and components of the build server 116.

The build server 116 includes one or more memories 410. The memory 410 comprises one or more computer-readable storage media (“CRSM”). The CRSM may be any one or more of an electronic storage medium, a magnetic storage medium, an optical storage medium, a quantum storage medium, a mechanical computer storage medium, and so forth. The memory 410 provides storage of computer readable instructions, data structures, program modules, and other data for the operation of the build server 116.

The memory 410 may include at least one operating system (“OS”) module 412. The OS module 412 is configured to manage hardware resources such as the I/O interface(s) 404 and network interface(s) 408, and to provide various services to applications or modules executing on the processor(s) 402.

The memory 410 may include a user interface module 414, a source code control module 416, the application 108, a build module 418, or other module(s) 420. The user interface module 414 is configured to provide a user interface to the one or more client devices 104. In some implementations the user interface may comprise a graphical user interface, and may be delivered as hypertext markup language (“HTML”) data configured for presentation on the client devices 104.

The source code control module 416 may be configured to provide control of source code, check-in/check-out of source code to users 102, and so forth. The build module 418 is configured to take associated source code and generate a build of the application 108. The application 108 as built comprises source code configured for execution on the host device 106.

In some implementations the functionality of the build server 116 may exist across one or more devices. For example, a first build server 116(1) may provide the user interface module 414 while a second build server 116(2) provides the source code control module 110, a third server 112(3) provides the build module 118, and so forth.

The memory 410 may also include a datastore 422 to store information for operations of the build server 116. The datastore 422 may comprise a database, array, structured list, tree, or other data structure. In some implementations, the datastore 422 may store the test package 122 before transmission to the test server 120, the test results 136 received from the test server 120, and so forth.

The test package 122 may include information including build information 122(1), executable files 122(2), custom tests 122(3), or other data 122(P) such as testing configuration data. The build information 122(1) may provide information indicative of libraries used, host devices 106 supported, build version number information, and so forth for a particular application build. For example, the build information 122(1) may indicate that the test package 122 includes build 1229.203.23.1 which is configured for execution on a particular computing device model from manufacturer “A”. The executable files 122(2) may include executable binaries, markup language applications, and so forth, which are configured for execution on the host devices 106.

The custom tests 122(3) comprise information indicative of tests, test scripts, designation portions of the application 108 to test, and so forth. For example, the user 102 may generate a custom test 122(3) to exercise particular functionality of the application 108. These custom tests 122(3) may comprise unit tests configured for use on the host devices 106 in the host device farm 132. For example, the custom tests 122(3) may include those developed in the OCUnit testing framework promulgated by sente.ch from Sen:te of Switzerland, Calabash as promulgated by lesspainful.com of Denmark, Frank as promulgated by testingwithfrank.com as associated with ThoughtWorks Inc. of Chicago, Ill. The test package 122 may include other data 122(P) such as user identification, account information, and so forth.

The custom tests 122(3) may be based at least in part on previously generated test scripts 130. For example, the test script 130 based on input data 112 from earlier use may be modified by the developer user 102 and resubmitted as a custom test 122(3). Likewise, the test results 136 may also be stored.

Other data 424 may also be stored, such as the API URL associated with the test server 120, historical test results, version information, code check-in/check-out information, build status, and so forth. To this end, the datastore 422 may be configured to store and maintain information relating to the testing of the application 108 including test success rates, as well as, failure reports augmented with context screenshots to pinpoint causes and activities at various crash times.

FIG. 5 depicts a block diagram 500 of the test server configured to generate test scripts and test the application 108 using these scripts. The test server 120 may include one or more processors 502 configured to execute one or more stored instructions. The processors 502 may comprise one or more cores. The test server 120 may include one or more I/O interface(s) 504 to allow the test server 120 to communicate with other devices. For example, the I/O interface(s) 504 may be configured to provide a universal serial bus (USB) connection to couple to the host device 106. The I/O interfaces 504 may also be known as “communication interfaces.”

The I/O interface(s) 504 may couple to one or more I/O devices 506, such as described above. In some embodiments, the I/O device(s) 506 may be physically incorporated with the test server 120 or be externally placed.

The test server 120 may also include one or more network interfaces 508 to enable communications between the test server 120 and other networked devices such as those depicted in FIG. 1. Such network interface(s) 508 may include one or more NICs or other types of transceiver devices configured to send and receive communications over the network(s) 118. For example, the network interface(s) 508 may be configured to provide a Wi-Fi connection compliant with one or more IEEE 802.11 standards such as 802.11g or 802.11n. The test server 120 may also include one or more busses or other internal communications hardware or software that allow for the transfer of data between the various modules and components of the test server 120.

The test server 120 may include one or more memories 510. The memory 510 comprises one or more CRSM as described above. The memory 510 provides storage of computer readable instructions, data structures, program modules, and other data for the operation of the test server 120.

The memory 510 may include at least one OS module 512. The OS module 512 is configured to manage hardware resources such as the I/O interface(s) 504 and network interface(s) 508, and to provide various services to applications or modules executing on the processor(s) 502.

The memory 510 may store one or more of the test server API module 124, an unpack module 514, the application validation module 126, a test file validation module 516, the test script generation module 128, the test result module 134, and so forth.

The test server API module 124 is configured to accept and respond to the test package 122, the input data 112, or other information sent by the client device 104, the host device 106, the build server 116, or both. The test server API module 124 may also be configured to send the test results 136 or other information to the client device 104, build server 116, or both. Use of the test server API module 124 allows the client device 104 and the build server 116 to integrate the testing functionality of the test server 120 into the automated or semi-automated testing processes associated with the application build.

The unpack module 514 may be configured to unpack the test package 122. The unpacking may include one or more of separating out the application build, tests, configuration data, build information, and so forth.

As described above, the application validation module 126 generates an object level hierarchy for the application, based on the assembly code generated by the assembly code generation module on the host device 106. In some cases, the test server 120 may iteratively query the assembly code on the host device 106 to determine parent/child hierarchical relationships between various objects associated with the application. The object level hierarchy may then be built based on these determined parent/child relationships. In some embodiments, the objects employed to build the object level hierarchy include those objects associated with a particular object type, aspect, or feature set of the application, and may also be known as “application objects”.

The application validation module 126 may also be configured to validate and verify that the application 108 meets design and development requirements. The test file validation module 516 may be configured to validate and verify that test package 122 is a valid file type for the particular framework that is used for testing the application 108.

The test script generation module 128 uses the input event data 114 to generate one or more test scripts 130. This test script 130 may be deployed to the host devices 106 in the host device farm 132 for use in testing the application 108. By using the test script 130 the user inputs, which may have been modified by the developer user 102(1), may be replayed to exercise the application 108 without human intervention.

The test result module 134 is configured to generate test results 136 based at least in part on information provided by one or more of the host devices 106. This information may be gathered during execution of the application 108. Other modules 518 may also be stored in the memory 510.

The memory 510 may also include a datastore 520 to store information for operations of the test server 120. The datastore 520 may comprise a database, array, structured list, tree, program code, or other data structure.

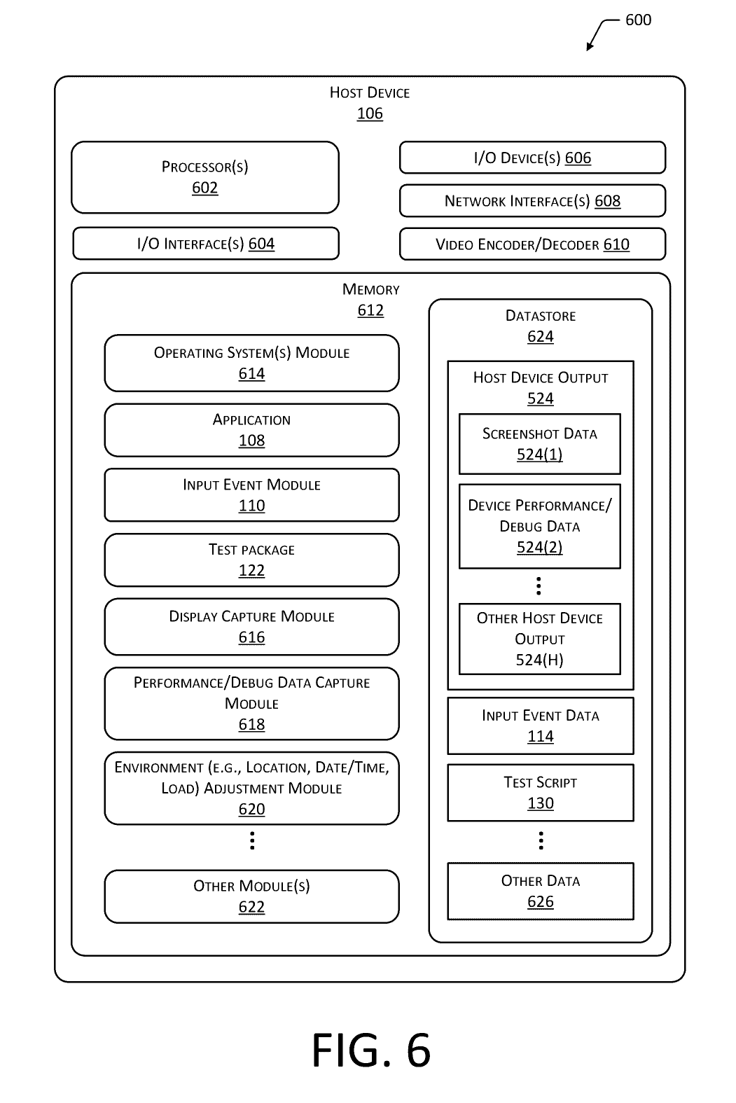

The datastore 520 may also include the test package 122 as received from the client device 104 or the build server 116 using the test server API module 124. The input event data 114 may also be stored. Testing frameworks 522 may also be stored in the datastore 520. Examples of various frameworks include OCUnit, UIAutomation, KIF, Calabash, Frank, and so forth. These testing frameworks enable users to create tests that automate tasks of testing functionality of the application 108 on one or more host devices 106. The one or more test scripts 130 may also be stored in the memory. Host device output 524 may also be stored. The host device output 524 comprises information received from the host devices 106 in the host device farm 132. The host device output 524 is discussed in more detail below with regard to FIG. 6.

The test results 136 may also be stored in the datastore 520, along with other data 526. The other data 526 may include account information, billing preferences, test configurations, and so forth. The test results 136 may include failure reports, screenshots for all of the test frameworks, logs of each of the host devices, user interface information, and any additional files that the test creates. Additionally, the test results 136 may include information related to anomalous occurrences during testing of the application 108 that have occurred by various causes, other than by defects or bugs in the application 108. In order to follow up the causes of the failures, detailed information on operating environments, statuses of the system in use, and so forth may also be included in the test results 136.

FIG. 6 depicts a block diagram 600 of the host device 106. As described above, the host device 106 may be controlled by the test server 120, or controlled by a user 102 directly operating the device in person. As described above, the host device farm 132 may be made up of one or more host devices 106 which may be used to test the application 108. The host device 106 may include one or more processors 602 configured to execute one or more stored instructions. The processors 602 may comprise one or more cores.

Similar to the devices described above, the host device 106 may include one or more I/O interface(s) 604 to allow the host device 106 to communicate with other devices. The I/O interface 604 may be configured to provide a USB connection.

The I/O interface 604 may couple to one or more I/O devices 606. The I/O devices 606 may include user input devices such as one or more of a keyboard, a mouse, a pen, a game controller, a voice input device, a touch input device, accelerometers, motion sensors, gestural input device, and so forth. The I/O devices 606 may include output devices such as one or more of a display, a printer, audio speakers, haptic output device, and so forth. In some embodiments, the I/O devices 606 may be physically incorporated with the host device 106 or be externally placed.

The host device 106 may also include one or more network interfaces 608 configured to send and receive communications over the one or more networks 118. The host device 106 may also include one or more busses or other internal communications hardware or software that allow for the transfer of data between the various modules and components of the host device 106.

The host device 106 may include a hardware-based video encoder/decoder 610. While a hardware-based video encoder/decoder is described, in some implementations a hardware-based video encoder may be used. The video encoder/decoder 610 may be incorporated into a common die with the one or more processors 602 or may be on a separate die. The video encoder/decoder 610 may be configured to enable the capture of screenshot data in the H.264 or MPEG-4 Part 10 compliant format.

The host device 106 includes one or more memories 612. The memory 612 comprises one or more CRSM, as described above. The memory 612 may include at least one OS module 614. The OS module 614 is configured to manage hardware resources such as the I/O interfaces 604 and provide various services to applications or modules executing on the one or more processors 602. The OS module 614 may comprise mobile operating systems configured for execution on mobile computing devices. The operating systems module 614 may implement one or more of iOS® from Apple Corp. of Cupertino, Calif.; Windows Mobile® from Microsoft Corp. of Redmond, Wash.; Android® from Google, Corp. of Mountain View, Calif. and its derivatives from various sources; Palm OS® from Palm Computing, Inc. of Sunnyvale, Calif. and its derivatives from various sources, BlackBerry OS® from Research In Motion Ltd. of Waterloo, Ontario, Canada; or other operating systems such as VxWorks from Wind River Systems of Alameda, Calif.

The memory 612 may also include one or more of the application 108, the test package 122, a display capture module 616, a performance/debug data capture module 618, an environment adjustment module 620, or other modules 622.

The application 108 is configured to execute on the host device 106. For example, this may be the application 108 received from the client device 104 or the build server 116.

The input event module 110 may be stored in the memory 612. As described above, the input event module 110 may comprise a SDK which is incorporated into the application 108 and is configured to generate the input event data 114.

In some cases, the test package 122 may reside on the host device 106. In such cases, the testing framework 522 may be inserted into the application 108 at runtime.

The display capture module 616 is configured to capture screenshots of the host device 106 display and generate screenshot data 524(1). The screenshot data 524(1) may be generated using the hardware-based video encoder/decoder 610. Use of the hardware-based video encoder/decoder 610 allows for the high-fidelity capture and presentation of images presented on the display of the host device 106. This high-fidelity is based on the ability to capture the screenshots at the full resolution and at the full frame rate or redraw rate of the display.

The performance/debug data capture module 618 is configured to capture one or more of: performance data about the host device 106, code-level debug data for apps or other processes running on the host device 106, and so forth. The information may be provided to the build server 116, the user 102, or both.

The environment adjustment module 620 is configured to adjust the host device 106 environment based on input from the test server 120. The environment includes OS, OS version, firmware, firmware version, language in use, date, time, location/position, orientation, and so forth.

The environment adjustment module 620 may modify the location of the host device 106 such that processes running on the host device 106 behave as though the host device were located in a location other than its actual, physical location. For example, the host device 106 may be located in a test facility in San Francisco, Calif., but the OS module 614 of the host device 106 or other applications may report a location of London, England.

The environment adjustment module 620 may also generate loads on the one or more processors 602, memory 612, I/O devices 606, or a combination thereof. For example, the environment adjustment module 620 may be configured to execute an application 108 which consumes 50% of the processor 602 resources and uses enough memory 612 to result in a low-memory state in the OS module 614. The application 108 may then be executed, and tested under these loaded conditions.

The other modules 622 may also be included in the host device 106. These other modules 622 may include, but are not limited to, other application modules not under test.

The memory 612 also includes a datastore 624 to store information for operations of host device 106. The datastore 624 may comprise a database, array, structured list, tree, or other data structure. The datastore 624 may store the host device output 524, which may comprise the screenshot data 524(1) generated by the display capture module 616. The screenshot data 524(1) may be stored until such data is retrieved from the host device 106 by the test server 120 or overwritten by the display capture module 616. The host device output 524 may also include device performance and/or debug data 524(2) gathered by performance/debug data capture module 618. As above, the data 524(2) may be stored until retrieved by the test server 120. Other host device output 524(H) may also be stored.

In some implementations at least a portion of the input event data 130 may be stored in the memory 612. In some implementations one or more of the test scripts 130 may be stored in the memory 612. For example, in some implementations a testing module may be present in the memory 612 and be configured to execute the application 108 using the one or more test scripts 130. Other data 626 may also be stored in the datastore 624.

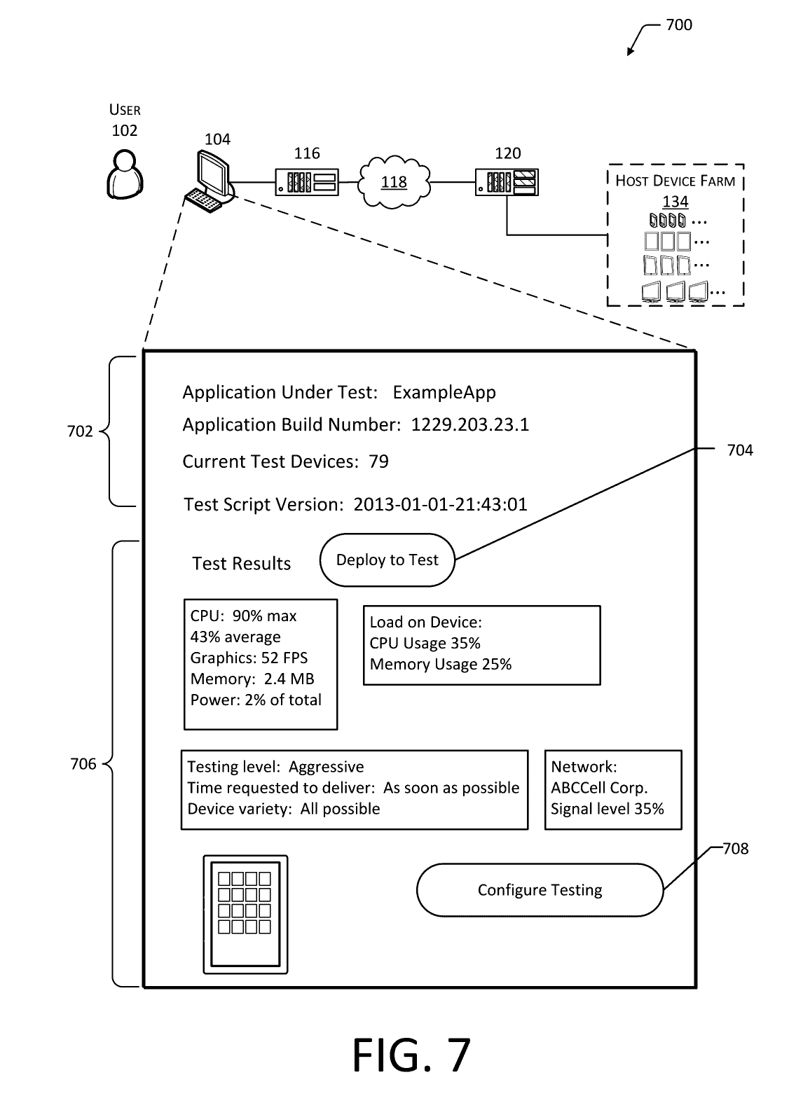

FIG. 7 depicts a user interface 700 of testing options and results which may be presented to a user 102. The interface 700 may comprise a web interface suitable for viewing within a web browser running on the client device 104 of the user 102. In some implementations, the data provided by the interface 700 may be copied into a file and reported to a user 102 in the file, in an email, or through other means. The data provided by the interface 700 may be stored in a file or other data format or structure, and provided to the user 102 or to a process in response to a request.

The interface 700 may include a summary section 702, describing characteristics of the application build. For example, as shown here it may indicate the name of the application 108 “ExampleApp”,the current build number “1229.203.23.1”, and which test script is selected for use. In this example, the application 108 is configured to use the test script “2013-01-01-21:43:01”.

A deploy-to-test control 704 may be presented. The control 704 is configured to, on activation, generate and send the test package 122 using the test server API 124 to the test server 120 for testing without further intervention by the user 102. The API 124 may plug into the existing code repositories associated with the application 108 and build systems. In some implementations the generation and sending of the test package 122 may be initiated automatically, such as at a pre-determined time, upon check-in of all portions of the application 108, upon completion of a process, and so forth

A current test parameter section 706 provides information about the current configuration of the tests to be completed. For example, the test parameters may specify particular date and time, geographic location, CPU loading and memory usage to be used during testing, network, orientation, and so forth. For example, as shown here the wireless wide area network is set to provide an environment representative of service from “ABCCell Corp.” with a signal level as received at the host device 106 of 35%.

The current test parameter section 706 may also provide information such as what tests are to be run, time frame to provide results, how to apply those tests, and so forth. For example, as shown here the testing level is set to “aggressive” in which all available tests will be scheduled to run against the application 108. The user 102 may specify a time requested to deliver, such as “as soon as possible,” “reduced cost,” and so forth. For example, the “as soon as possible” may prioritize and conduct tests for the application 108 ahead of other applications 108 which have selected the “reduced cost” option. The “reduced cost” option may thus be offered at a lower cost relative to the “as soon as possible” option given the potential delay in providing the test results 136. Host device 106 variety may also be specified, enabling the application 108 to be tested against all available devices compatible with the application 108, against a certain model, and so forth. This allows for testing to be conducted easily and quickly with several models of the host device 106. For example, the host device farm 132 may include legacy host devices 106 which are no longer available for purchase, or pre-release models of a next-generation host device 106 to allow for advance testing.

A configure testing control 708 may be presented. The configure testing control 708 is configured to, on activation, provide for modification of one or more of the test parameters. In one implementation, activation of the configure testing control 708 may present a user interface allowing the user 102 to change the test parameters. For example, the user 102 may select options to enable debug options which provide details on UIView. In some implementations, the user 102 may configure the testing to use a particular group of different test scripts 130, or to use a random or otherwise selection of different test scripts 130 for testing.

A test results section (not depicted) may provide information based at least in part on the test results 136 as received from the test server 120. The information may include screenshot data 524(1), device performance/debut data 524(2), and so forth. For example, the user 102 may watch a stream of video taken during a portion of the testing of the application 108 on the one or more host devices 106 to observe behavior during testing. Other information such as UIView details, a portion of a UI layout hierarchy dump, application load times, web site load times, and so forth may also be presented. The output of the test results 136 may be configurable to meet the specific requirements of particular users 102. For example, test results 136 may be filtered based at least in part on device type prior to being presented to a user 102.

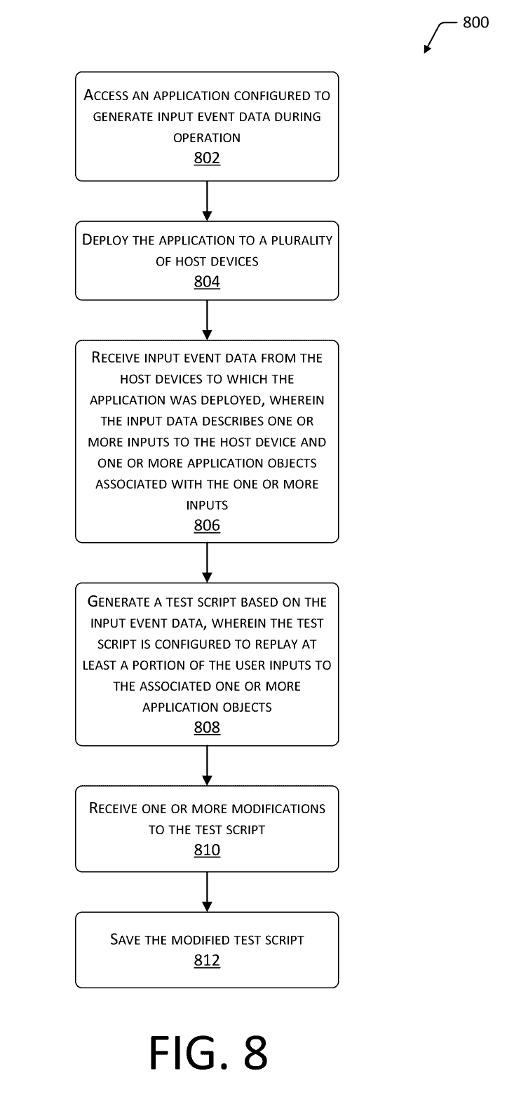

FIG. 8 depicts a flow diagram 800 of a process to use input event data to generate a test script. This process may be implemented by one or more of the host device 106, the client device 104, the build server 116, or the test server 120.

Block 802 accesses an application 108 configured to generate input event data 114 during operation. As described above, the input event data 114 may comprise input data 112 such as one or more touch inputs received by a touch sensor. The input event module 110 is configured to use the input data 112 and determine the one or more application objects 310 which are associated with the input data 112. In one implementation, the application objects 310 may comprise UIView objects as defined within a UIAutomation framework and the test script comprises JavaScript compliant with the UIAutomation framework.

The input data 112 includes information indicative of input from one or more input sources. The input data 112 may include one or more of: button input 204, audio input 206, proximity sensor input 208, ambient light sensor input 210, camera input 212, accelerometer input 214, gyroscope input 216, magnetometer input 218, location input 220, or network condition 222 indicative of one or more wireless networking connections.

The application 108 may be configured to generate the input event data 114 with the input event module 110. The input event module 110 may utilize code or instructions which are dynamically injected into the application 108 at runtime, or which are linked or otherwise incorporated or inserted into the application 108 at compile time. For example, the input event module 110 may be implemented as a software development kit (“SDK”). The instructions are configured to store the one or more inputs in the input data 112, such as touch inputs, and information indicative of the associated one or more application objects 310. The application 108 may be further configured to generate an object level hierarchy of the application, such as described above.

Block 804 deploys the application 108 to one or more host devices 106. For example, the application 108 with the input event module 110 may be sent to the host device 106 used by one or more users 102, in the host device farm 132, or both. The application 108 may then be executed on the one or more host devices 106.

Block 806 receives the input event data 114 from the one or more host devices 106. These are the host devices 106 to which the application 108 was deployed. As described above, the input event data 114 comprises input data 112 and associated application objects 310.

Block 808 generates one or more test scripts 130 based on the input event data 114. The test script 130 is configured to replay at least a portion of the user inputs to the associated one or more application objects 310. The test script 130 comprises one or more instructions configured to, when executed on the host device 106, operate the one or more application objects 310 in the application 108. In some implementations where the object level hierarchy is available, the test script 130 may further comprise one or more comments based at least in part on the object level hierarchy. These comments may be useful to the developer user 102 while reviewing or modifying the test script 130. In some implementations, the one or more comments may include references to one or more images of a graphical user interface of the application 108 at a point during execution of the input data 112. For example, screenshots may be acquired from the host devices 106 and appended to or included in the input data 112. The references comprising one or more hyperlinks, filenames, or pointers.

Block 810 receives one or more modifications to the test script. These modifications may be received from the developer user 102, an automated process, or both. For example, the developer user 102 may modify the test script 130 to include logic to exercise different functions.

Block 812 saves the modified test script 130. The modified test script 130 may then be accessed by the test result module 134 or another module to exercise the application 108 in further tests.

Another block (not illustrated) may test the application 108 or a subsequent build of the application 108 using the test script 130, as modified or not, on a plurality of host devices 106, such as in the host device farm 132.

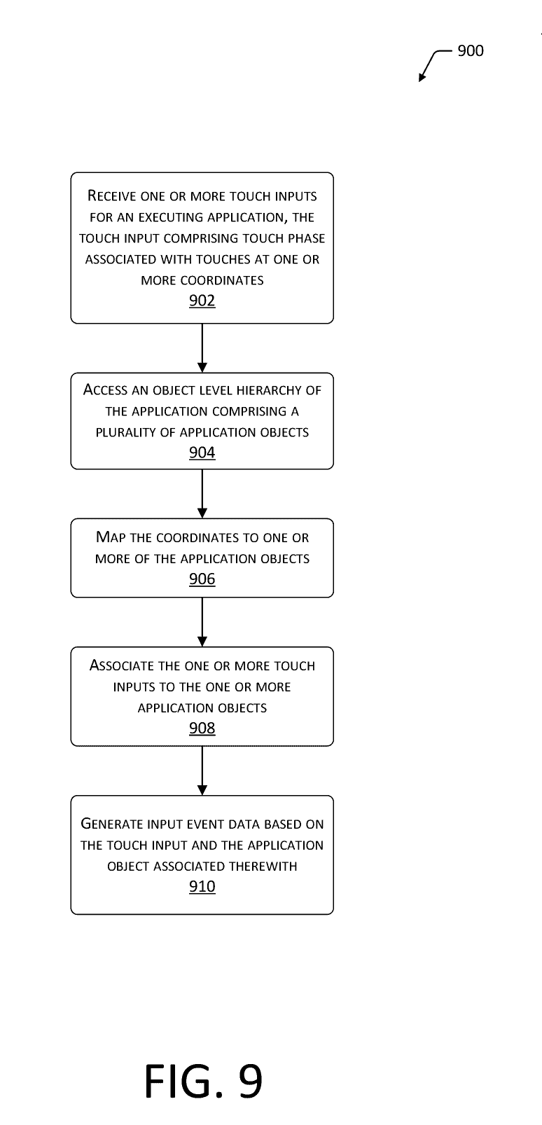

FIG. 9 depicts a flow diagram 900 of a process to generate input event data based on touch inputs. This process may be implemented by one or more of the host device 106, the client device 104, the build server 116, or the test server 120.

Block 902 receives input data 112 from one or more input devices. This input data 112 is associated with the execution of the application 108. For example, user 102 touches on a touch sensor, button presses, audio input, and so forth. These inputs may comprise one or more touch inputs. The touch inputs 202 may include one or more touch phases associated with one or more coordinates on the touch sensor. The touch sensor may comprise a touchscreen or other input device which provides information indicative of the position of one or more portions of the user's 102 hand or another physical object.

As described above, the input data 112 includes information indicative of input from one or more input sources. The input data 112 may include one or more of: button input 204, audio input 206, proximity sensor input 208, ambient light sensor input 210, camera input 212, accelerometer input 214, gyroscope input 216, magnetometer input 218, location input 220, or network condition 222 indicative of one or more wireless networking connections.

Block 904 accesses an object level hierarchy of the application 108 comprising a plurality of application objects 310 associated with one or more user interface elements of the application. In some implementations, the object level hierarchy may be generated at least in part by the application validation module 126, the input event module 110, or another module.

Block 906 maps the input data 112 to one or more of the application objects 310. For example, a touch input may comprise one or more coordinates for a control which is mapped to a particular application object 310 which represents the control. For example, the touch input data is associated with the application object 310(1).

Block 908 associates the input data 112, such as the one or more touch inputs, to the one or more application objects, based at least in part on the mapping. Continuing the example, the “tap” input is associated with the application object 310(1). For example, in one implementation the coordinates of the touch input 202 may be within a zone associated with the application object 310.

Block 910 generates the input event data 114 based on the input data 112, such as the touch input, and the associated application object 310. The event data 114 now comprises information which indicates input which was received and what application object 310(1) received that input.

Additional blocks, such as those described above, may provide additional functions. A block may generate one or more test scripts 130 based on the input event data 114. The test script 130 comprises one or more instructions configured to, when executed, operate or otherwise exercise the one or more application objects 310 in the application 108.

The generation of the test scripts 130 may be done at least initially without user intervention. As described above, the user 102 may use and interact with the application 108. That interaction is recorded as the input data 112, which is used to generate the input event data 114 from which the test scripts 130 may be generated. Using this technique, the test scripts 130 may be initially generated by a user 102 with no programming skills. As described above, in some implementations the developer user 102 may then modify the test scripts 130.

To facilitate development, the test script 130 may include one or more comments. These comments may also be automatically generated and may include information from, or based at least in part on, the object level hierarchy.

Once generated, additional blocks may execute the test script 130 on one or more host devices 106, such as those in the host device farm 132, to exercise the application 108. The output from that execution may be stored and retrieved from the plurality of host devices 106, and used by the test result module 134 to generate test results 136.

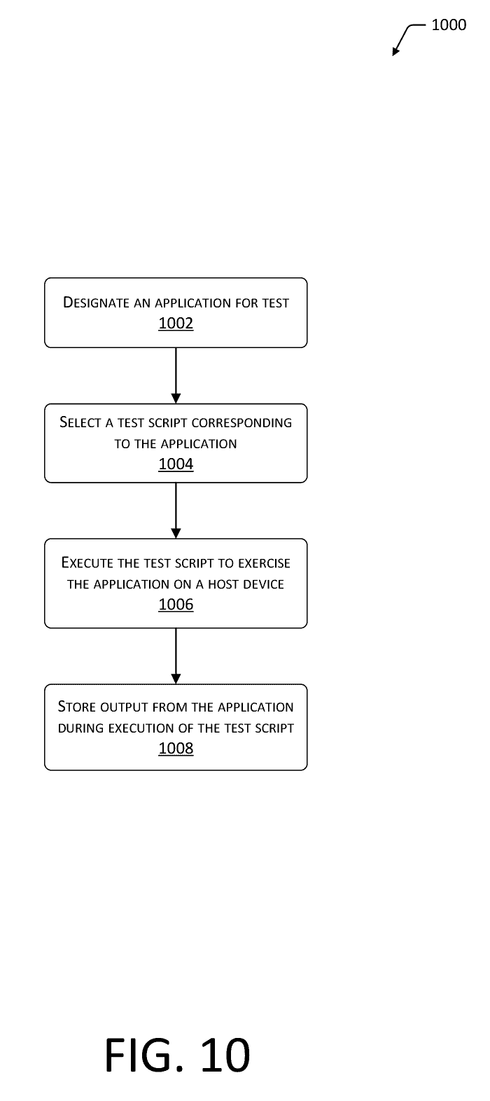

FIG. 10 depicts a flow diagram 1000 of a process of application testing using the generated test script. This process may be implemented by one or more of the host device 106, the client device 104, the build server 116, or the test server 120.

Block 1002 designates an application 108 for test. For example, the developer user 102 may select a particular application 108 undergoing development, and send this application to the test server 120 using the test server API module 124.

Block 1004 selects a test script 130 corresponding to the application 108. This test script 130 may have been previously generated at least in part automatically using the techniques described above. Continuing the example, the developer user 102 may select a particular test script 130 of interest, indicate selection of test scripts 130, select a random test script 130, and so forth.

Block 1006 executes the test script 130 to exercise the application 108 on one or more host devices 106. For example, this may be an individual host device 106 operating independently, connected to the client device 104, or in the host device farm 132.

Block 1008 stores output from the application 108 during execution of the test script 130. This output may be accessed by the test result module 134 to generate one or more test results 136. As described above, the test results 136 may then be used for further development.

As development continues, changes to and new builds of the application 108 may render the existing test scripts 130 inoperable or inappropriate. The developer user 102 may use or implement the techniques described above to generate additional test scripts 130.

Those having ordinary skill in the art will readily recognize that certain steps or operations illustrated in the figures above can be eliminated, combined, subdivided, executed in parallel, or taken in an alternate order. Moreover, the methods described above may be implemented as one or more software programs for a computer system and are encoded in a computer-readable storage medium as instructions executable on one or more processors. The sample code included in this disclosure is provided by way of illustration.

Separate instances of these programs can be executed on, or distributed across, separate computer systems. Thus, although certain steps have been described as being performed by certain devices, software programs, processes, or entities, this need not be the case and a variety of alternative implementations will be understood by those having ordinary skill in the art.

Additionally, those having ordinary skill in the art readily recognize that the techniques described above can be utilized in a variety of devices, environments, and situations. Although the present disclosure is written with respect to specific embodiments and implementations, various changes and modifications may be suggested to one skilled in the art and it is intended that the present disclosure encompass such changes and modifications that fall within the scope of the appended claims.

1. A method, comprising:
designating, at a test server, an application for test, wherein the application comprises a user interface including one or more user interface elements, and wherein the application further comprises one or more application objects respectively associated with one or more particular features of the application;
determining, at the test server, an object level hierarchy for the one or more application objects, wherein the object level hierarchy relates the one or more application objects and the one or more user interface elements;
receiving, at the test server, input data comprising information describing a portion of a touch related to a particular touch input received by one or more touch sensors and one or more coordinates of the particular touch input, wherein the portion of the touch includes at least one of: a beginning of the touch, an end of the touch, and a move of the touch;
determining a particular user interface element of the one more user interface elements corresponding to the one or more coordinates using the test server;
determining, by the test server, an association between the particular touch input and a particular application object of the one or more application objects based on the object level hierarchy;
generating, by the test server, input event data based on the input data and the association between the particular touch input and the particular application object, the input event data comprising a first indication that includes information about the particular touch input and information about the particular application object, wherein the information about the particular touch input comprises the information describing the portion of the touch related to the particular touch input; and
generating a test script based on input event data comprising the first indication, wherein the test script comprises one or more instructions configured to, when executed, replay at least one touch input of one or more touch inputs that include the particular touch input to at least one application object of the one or more application objects to operate the at least one application object in the application.

2. The method of claim 1, the input event data further comprising information indicative of input data from one or more inputs and associated with one or more application objects, the input data comprising one or more of: button input, audio input, proximity sensor input, ambient light sensor input, camera input, accelerometer input, gyroscope input, magnetometer input, location input, or network condition indicative of one or more wireless networking connections.

3. The method of claim 1, wherein the application is further configured for comprising dynamically injecting instructions into the application at runtime, wherein the instructions are configured to store the one or more touch inputs and information indicative of the associated one or more application objects.

4. The method of claim 1, wherein the application is further configured for inserting instructions into the application at compile time, wherein the instructions are configured to store the one or more touch inputs and information indicative of the one or more application objects.

5. The method of claim 1, wherein the one or more application objects comprise objects defined within a framework and the test script comprises script instructions compliant with the framework.

6. The method of claim 1, further comprising employing the test script to test the application on a plurality of host devices.

7. The method of claim 1, wherein the test script further comprises one or more comments based at least in part on the object level hierarchy.

8. The method of claim 7, the one or more comments further comprising references to one or more images of a graphical user interface of the application at a point during execution of the input data, the references comprising one or more hyperlinks, filenames, or pointers.

9. A non-transitory computer readable medium storing instructions, which when executed by a processor, cause the processor to perform actions comprising:
receiving an object level hierarchy for the one or more application objects of an application, wherein the object level hierarchy relates the one or more application objects and one or more user interface elements of a user interface of the application;
executing the application to display the user interface, wherein the user interface is associated with one or more input devices, wherein the one or more user interface elements are associated with respective particular areas on the display, and wherein the one or more application objects are respectively associated with one or more particular features of the application;
receiving a touch input from at least one of the one or more input devices during execution of the application, wherein the touch input is associated with one or more touch coordinates indicating a location on the display;
associating a particular user interface element of the one or more user interface elements with the touch input based on the one or more touch coordinates;
associating a particular application object of the plurality of application objects and the particular user interface element based on the object level hierarchy;
comparing one or more coordinates in the touch input with one or more application objects in the object level hierarchy to generate a first indication that the touch input was provided as an input to the particular application object, wherein the first indication comprises information describing a portion of a touch related to the touch input, and wherein the portion of the touch includes at least one of: a beginning of the touch, an end of the touch, and a move of the touch; and
generating input event data based on the touch input and the particular application object, wherein the input event data comprises the first indication.

10. The non-transitory computer readable medium of claim 9, the input event data describing further comprising data related to one or more of button input, audio input, proximity sensor input, ambient light sensor input, camera input, accelerometer input, gyroscope input, magnetometer input, location input, or network condition indicative of one or more wireless networking connections.

11. The non-transitory computer readable medium of claim 10, wherein the actions further comprise:
receiving a test script that is based on the input event data, wherein the test script comprises one or more instructions configured to, when executed, operate the one or more application objects in the application.

12. The non-transitory computer readable medium of claim 11, wherein the actions further comprise:
executing the test script.

13. (canceled)

14. The non-transitory computer readable medium of claim 12, further comprising:
employing the test script to test the application on a plurality of host devices.

15. A test server, comprising:
at least one processor; and
at least one memory coupled to the at least one processor and storing instructions configured for execution on the at least one processor, the instructions configured to:
designate an application for test, wherein the application comprises a user interface including one or more user interface elements, and wherein the application further comprises one or more application objects associated with one or more respective features of the application;
determine an object level hierarchy comprising for the one or more application objects, wherein the object level hierarchy relates the one or more application objects and the one or more user interface elements;
provide the object level hierarchy;
receiving input data comprising information describing a portion of a touch related to a particular touch input received by one or more touch sensors and one or more coordinates of the particular touch input, wherein the portion of the touch includes at least one of: a beginning of the touch, an end of the touch, and a move of the touch;
determine a particular user interface element of the one more user interface elements corresponding to the one or more coordinates;
determine an association between the particular touch input and a particular application object of the one or more application objects based on the object level hierarchy;
generating input event data based on the input data and the association between the particular touch input and the particular application object, the input event data comprising a first indication that includes information about the particular touch input and information about the particular application object, wherein the information about the particular touch input comprises the information describing the portion of the touch related to the particular touch input; and
generate one or more test scripts based on input event data comprising the first indication, wherein the one or more test scripts comprise one or more instructions configured to, when executed, replay at least one touch input of one or more touch inputs that include the particular touch input to at least one application object of the one or more application objects to operate the at least one application object in the application.

16. The test server of claim 15, wherein the one or more test scripts are initially generated automatically without user intervention.

17. The test server of claim 16, further comprising instructions to modify the one or more test scripts based at least in part on an input.

18. The test server of claim 15, wherein determining the object level hierarchy comprises generating the object level hierarchy.

19. The test server of claim 15, wherein the one or more test scripts further comprises one or more comments based on the object level hierarchy.

20. The test server of claim 15, further comprising instructions to:
access additional input event data associating one or more additional inputs with the one or more application objects of the application during execution, the one or more additional inputs comprising one or more of: button input, audio input, proximity sensor input, ambient light sensor input, camera input, accelerometer input, gyroscope input, magnetometer input, location input, or network condition indicative of one or more wireless networking connections.
